(19) United States
(12) Patent Application Publication
(10) Pub. No.: US 2022/0259438 A1
(43) Pub. Date: Aug. 18, 2022

(54) ALKALI METAL SILICATE COATING AND PREPARATION METHOD THEREOF

(71) Applicant: HIGHCHEM CO., LTD., Tokyo (JP)

(72) Inventors: Honggou LI, Tokyo (JP); Ushio TAKA, Tokyo (JP)

(21) Appl. No.: 17/610,981

(22) PCT Filed: May 12, 2020
(86) PCT No.: PCT/CN2020/089777

§ 371 Date: Nov. 12, 2021

(30) Foreign Application Priority Data
May 16, 2019 (CN) 201910406558.2

(51) Int. Cl. C09D 1/02; C09D 5/02; C09D 5/18; G01B 15/02

(52) U.S. Cl. CPC C09D 1/02; G01B 15/02; C09D 5/18; C09D 5/021

(57) ABSTRACT

The present invention relates to an alkali metal silicate coating formed from alkali metal silicate represented by the chemical formula M₂O.nSiO₂ and lithium silicate represented by the chemical formula Li₂O.mSiO₂, wherein M is selected from sodium, potassium, or a mixture thereof, n is from 2.9 to 3.7, m is from 4.2 to 4.8, and the molar ratio of M₂O.nSiO₂ to Li₂O.mSiO₂ is from 2.2 to 4.8; wherein the alkali metal silicate coating has a thickness of from 630 to 1,450 mg/m², preferably from 700 to 1,400 mg/m², in terms of SiO₂ as measured by fluorescent X-ray spectrometry. The present invention further relates to a preparation method of the coating. The coating of the present invention has excellent heat resistance, hot water resistance and stain resistance, as well as excellent damage resistance.

### TECHNICAL FIELD

The present invention relates to an alkali metal silicate coating and a preparation method thereof, as well as an article having an alkali metal silicate coating. The present invention further relates to a method of measuring the thickness of a silicate coating.

### BACKGROUND

Sodium silicate or potassium silicate is an inorganic material. When they are used in a coating, the resulting coating is expected to have good heat resistance, hardness and hydrophilicity. However, the primary disadvantage of such a coating is insufficient water resistance.

Curing agents such as polyvalent metal ions, acids and organics may be added to improve water resistance. However, curing starts as soon as the curing agent is added and the coating material thus needs to be used up as soon as possible. Therefore, there is a problem with the storability of the coating material. In addition, a method of coating the sodium silicate or potassium silicate coating material and the curing agent separately has been contemplated, but this requires coating for many times, and thus has a disadvantage of involving complicated operations. Therefore, there exists a need for a coating material which has good storability and a method capable of accomplishing coating treatment at one time.

The patent literature Japanese Patent Application Publication No. H07-018202 discloses a coating material formed from a mixture of an aqueous solution of alkali metal silicate represented by the formula M₂O.nSiO₂ (in the formula, M represents sodium and/or potassium, and n represents a number of from 2.0 to 4.1) and an aqueous solution of lithium silicate represented by the formula Li₂O.mSiO₂ (in the formula, m represents a number of from 4 to 5), wherein the molar ratio of M₂O.nSiO₂ to Li₂O.mSiO₂ is from 1 to 3.

Through the technology of Japanese Patent Application Publication No. H07-018202, even though sodium silicate and potassium silicate are mixed with lithium silicate, the curing reaction does not occur as if the curing agent is mixed, and a long-term storage is allowed. Furthermore, since the coating treatment can be accomplished by coating at one time, the operations are not considered to be complicated. Moreover, water resistance can be ensured by treatment at a temperature of from 110 to 150° C.

However, although the coating obtained through the technology in Japanese Patent Application Publication No. H07-018202 has the improved water resistance against water at room temperature, it still has a disadvantage of insufficient resistance against hot water at a temperate of 60° C. or above. Moreover, said literature explicitly discloses that the resulting coating will foam and collapse in water if it is heated at a temperature of 170° C. or above. This indicates that the resulting coating cannot be used at a temperature of 170° C. or above and in an environment exposed to hot water, which means that the obtained coating has a narrow range of applications.

Therefore, there still exists a need in the art for silicate coatings which have stain adhesion resistance, heat discoloration resistance, damage resistance, heat resistance and hot water resistance, especially silicate coatings that can be used for metal articles.

### SUMMARY OF THE INVENTION

In view of the state of the prior art as described above, the inventor of the present invention has conducted extensive and in-depth researches on alkali metal silicate coatings in order to find an alkali metal silicate coating with excellent performance. It is found that the alkali metal silicate coating of the present invention has excellent heat resistance, hot water resistance and stain resistance, as well as excellent damage resistance. Furthermore, the preparation of the coating of the present invention is simple and can be accomplished by coating at only one time and baking, thereby achieving cost reduction.

The technical solutions to achieve the object of the present invention can be summarized as follows:

1. An alkali metal silicate coating formed from alkali metal silicate represented by the chemical formula M₂O.nSiO₂ and lithium silicate represented by the chemical formula Li₂O.mSiO₂, wherein M is selected from sodium, potassium, or a mixture thereof, n is from 2.9 to 3.7, m is from 4.2 to 4.8, and the molar ratio of M₂.nSiO₂ to Li₂O.mSiO₂ is from 2.2 to 4.8;

wherein the alkali metal silicate coating has a thickness of from 630 to 1,450 mg/m², preferably from 700 to 1,400 mg/m², in terms of SiO₂ as measured by fluorescent X-ray spectrometry.

2. The alkali metal silicate coating according to Item 1, wherein the molar ratio of M₂.nSiO₂ to Li₂O.mSiO₂is from 2.3 to 4.5, preferably from 2.4 to 4.4.

3. The alkali metal silicate coating according to Item 1 or 2, wherein M is sodium or potassium.

4. The alkali metal silicate coating according to any one of Items 1 to 3, wherein is from 3.0 to 3.7, and/or m is from 4.3 to 4.7.

5. A preparation method of an alkali metal silicate coating, comprising

(i) providing a mixed aqueous solution comprising alkali metal silicate represented by the chemical formula M₂O.nSiO₂ and lithium silicate represented by the chemical formula Li₂O.mSiO₂, wherein M is selected from sodium, potassium, or a mixture thereof, n is from 2.9 to 3.7, m is from 4.2 to 4.8, and the molar ratio of M₂O.nSiO₂ to Li₂O.mSiO₂ is from 2.2 to 4.8; and

(ii) coating the mixed aqueous solution in step (i) on the surface of a substrate and then baking at a temperature of from 200 to 550° C.

6. The method according to Item 5, wherein the molar ratio of M₂O.nSiO₂ to Li₂O.mSiO₂ is from 2.3 to 4.5, preferably from 2.4 to 4.4.

7. The method according to Item 5 or 6, wherein M is sodium or potassium.

8. The method according to any one of Items 5 to 7, wherein n is from 3.0 to 3.7, and/or m is from 4,3 to 4.7.

9. The method according to any one of Items 5 to 8, wherein the mixed aqueous solution in step (i) is prepared by mixing an aqueous solution of alkali metal silicate represented by the chemical formula M₂O.nSiO₂ with an aqueous solution of lithium silicate represented by the chemical formula Li₂O.mSiO₂.

10. The method according to any one of Items 5 to 9, wherein the baking in step (ii) is carried out at a temperature of from 200 to 500° C., preferably from 200 to 300° C.

11. The method according to any one of Items 5 to 10, wherein the alkali metal silicate coating has a thickness of from 630 to 1,450 mg/m², preferably from 700 to 1,400 mg/m², in terms of SiO₂ as measured by fluorescent X-ray spectrometry.

12. The method according to any one of Items 5 to 11, wherein the baking in step (ii) is carried out for a duration of from 15 minutes to 2 hours, preferably from 20 minutes to 1 hour.

13. The method according to any one of Items 5 to 12, wherein the substrate is a metal, preferably iron, aluminium, an iron alloy such as stainless steel, an aluminium alloy, or copper, and more preferably an iron alloy such as stainless steel or aluminium.

14. An article having the alkali metal silicate coating according to any one of Items 1 to 4, or an article having an alkali metal silicate coating prepared by the method according to any one of Items 5 to 13.

15. The article according to Item 14, wherein the article is a metal article, preferably an article of iron, aluminium, an iron alloy such as stainless steel, an aluminium alloy, or copper, and more preferably an article of an iron alloy such as stainless steel or aluminium.

16. A product manufactured from the metal article according to Item 14 or 15, such as a kitchen product, a home appliance product, and a vehicle-related product.

17. A method of measuring the thickness of a silicate coating by fluorescent X-ray spectrometry.

18. The method according to Item 17, wherein the thickness of the silicate coating is from 50 to 10,000 mg/m², preferably from 100 to 5,000 mg/m², and more preferably from 200 to 3,000 mg/m², in terms of SiO₂.

19. The method according to Item 17 or 18, wherein the silicate coating is the coating according to any one of Items 1 to 4 or a coating prepared by the method according to any one of Items 5 to 13.

### DETAILED DESCRIPTION

One aspect of the present invention relates to an alkali metal silicate coating formed from alkali metal silicate represented by the chemical formula M₂O.nSiO₂ and lithium silicate represented by the chemical formula Li₂O.mSiO₂, wherein M is selected from sodium, potassium or a mixture thereof, n is from 2.9 to 3.7, m is from 4.2 to 4.8, and the molar ratio of M₂O.nSiO₂ to Li₂O.mSiO₂ is from 2.2 to 4.8;

wherein the alkali metal silicate coating has a thickness of from 630 to 1,450 mg/m², preferably from 700 to 1,400 mg/m², in terms of SiO₂ as measured by fluorescent X-ray spectrometry.

In a preferred embodiment of the present invention, the molar ratio of M₂O.nSiO₂ to Li₂O.mSiO₂ is from 2.3 to 4.5, preferably from 2.4 to 4.4, such as 2.4, 2.6, 2.8, 3.0, 3.2, 3.4, 3.6, 3.8, 4.0, 4.2, and 4.4.

In the alkali metal silicate represented by the chemical formula M₂O.nSiO₂, M is preferably sodium or potassium.

In a preferred embodiment of the present invention, in the alkali metal silicate represented by the chemical formula M₂O.nSiO₂, n is from 3.0 to 3.7, such as 3.0, 3.1, 3.2, 3.3, 3.4, 3.5, 3,6, or 3.7. If n is less than 2.9, the hot water resistance at a temperature of 60° C. or above would decrease even if the water resistance at room temperature is achieved. Moreover, if n is more than 3.7, the surface of the coating after baking would become rough, and then tend to turn white and foam when it is heated at a high temperature of 400° C.

In a preferred embodiment of the present invention, in the lithium silicate represented by the chemical formula Li₂O.mSiO₂, m is from 4.3 to 4.7, such as 4.3, 4.4, 4.5, 4.6, or 4.7. If m is less than 4.2, the hot water resistance would decrease. If m is more than 4.8, the surface of the coating would become rough, and further foam and whiten.

According to the present invention, the alkali metal silicate coating has a thickness of from 630 to 1,450 mg/m², preferably from 700 to 1,400 mg/m², such as 700, 800, 900, 1,000, 1,100, 1,200, 1,300, or 1,400 mg/m², in terms of SiO₂ as measured by fluorescent X-ray spectrometry. For the measurement of coating thickness by fluorescent X-ray spectrometry, the intensity of the characteristic X-ray Kα line of SiO₂ standard sample with a known thickness (mg/m²) can be pre-measured, so as to prepare calibration curves of thickness in terms of SiO₂. Then the intensity of the Kα line of a prepared test sample with an unknown thickness is measured, so as to calculate the thickness in terms of SiO₂ based on the calibration curves. With regard to fluorescent X-ray spectrometry, a X-MET8000 fluorescent X-ray analyser manufactured by Hitachi High-Technologies Corporation can be used.

According to the present invention, if the thickness is less than 630 mg/m² in terms of SiO₂, the hardness of the coating and the resistance against metal discoloration at high temperatures would be insufficient. On the other hand, if the thickness is more than 1,450 mg/m² in terms of SiO₂, the coating would exhibit undesirable events such as foaming and whitening when it is heated.

According to another aspect of the present invention, the present invention relates to a preparation method of an alkali metal silicate coating, comprising:

(i) providing a mixed aqueous solution comprising alkali metal silicate represented by the chemical formula M₂O.nSiO₂ and lithium silicate represented by the chemical formula Li₂O.mSiO₂, wherein M is selected from sodium, potassium, or a mixture thereof, n is from 2.9 to 3.7, m is from 4.2 to 4.8, and the molar ratio of M₂O.nSiO₂ to Li₂O.mSiO₂ is from 2.2 to 4.8; and

(ii) coating the mixed aqueous solution in step (i) onto the surface of a substrate and then baking at a temperature of from 200 to 550° C.

In a preferred embodiment of the present invention, the molar ratio of M₂O.nSiO₂ to Li₂.mSiO₂ may be from 2.3 to 4.5, preferably from 2.4 to 4.4, such as 2.4, 2.6, 2.8, 3.0, 3.2, 3.4, 3.6, 3.8, 4.0, 4.2, and 4.4.

In the alkali metal silicate represented by the chemical formula M₂O.nSiO₂, M is preferably sodium or potassium.

In a preferred embodiment of the present invention, in the alkali metal silicate represented by the chemical formula M₂O.nSiO₂, n is from 3.0 to 3.7, such as 3,0, 3.1, 3.2, 3.3, 3.4, 3,5, 3,6, or 3.7.

In a preferred embodiment of the present invention, in the lithium silicate represented by the chemical formula Li₂O.mSiO₂, m is from 4.3 to 4.7, such as 4.3, 4.4, 4.5, 4.6, or 4.7.

In an embodiment, the mixed aqueous solution in step (i) may have a solid content of from 10 to 33% by weight, preferably from 15 to 25% by weight.

In a preferred embodiment of the present invention, the mixed aqueous solution in step (i) is prepared by mixing an aqueous solution of alkali metal silicate represented by the chemical formula M₂O.nSiO₂ with an aqueous solution of lithium silicate represented by the chemical formula Li₂O.mSiO₂.

In the preparation of the mixed aqueous solution of an aqueous solution of alkali metal silicate represented by the chemical formula M₂O.nSiO₂ and an aqueous solution of lithium silicate represented by the chemical formula Li₂O.mSiO₂, additional water may be added. By adding water, the viscosity of the mixed aqueous solution may be reduced, thereby facilitating coating.

In an embodiment, the aqueous solution of alkali metal silicate represented by the chemical formula M₂O.nSiO₂ may have a concentration of about from 10 to 40% by weight.

In an embodiment, the aqueous solution of lithium silicate represented by the chemical formula Li₂O.mSiO₂may have a concentration of about from 10 to 25% by weight.

Spraying, roll coating, dipping, brush coating, etc. may be used as coating methods, without particular limitations.

In a preferred embodiment of the present invention, the alkali metal silicate coating has a thickness of from 630 to 1,450 mg/m², preferably from 700 to 1,400 mg/m², such as 700, 800, 900, 1,000, 1,100, 1,200, 1,300, or 1,400 mg/m², in terms of SiO₂ as measured by fluorescent X-ray spectrometry. The measurement of the thickness can be carried out as described above.

In a preferred embodiment of the present invention, the baking in step (ii) is carried out at a temperature of from 200 to 500° C., such as 200° C., 300° C., 400° C., or 500° C., preferably from 200 to 300° C., such as 250° C. If it is lower than 200° C., the hot water resistance tends to decrease. If it is higher than 550° C., the coating film tends to whiten.

In an embodiment of the present invention, prior to baking in step (ii), the coated substrate is naturally dried. The drying may be carried out for a duration of from 5 minutes to 30 minutes, preferably from 8 minutes to 20 minutes.

In an embodiment of the present invention, the baking in step (ii) is carried out for a duration of from 15 minutes to 2 hours, preferably from 20 minutes to 1 hour, such as 30 minutes or 45 minutes.

According to a preferred embodiment of the present invention, the substrate is a metal, preferably iron, aluminium, an iron alloy such as stainless steel, an aluminium alloy, or copper, and more preferably an iron alloy such as stainless steel or aluminium.

The present invention further relates to an article having the alkali metal silicate coating of the present invention, or an article having an alkali metal silicate coating which may be prepared by the method of the present invention.

In a preferred embodiment of the present invention, the article is a metal article, preferably an article of iron, aluminium, an iron alloy such as stainless steel, an aluminium alloy, or copper, and more preferably an article of an iron alloy such as stainless steel or aluminium.

The present invention further relates to a product manufactured from the metal article of the present invention, such as a kitchen product, a home appliance product, and a vehicle-related product.

In an aspect of the present invention, the present invention further relates to a method of measuring the thickness of a silicate coating by fluorescent X-ray spectrometry. Measurement of thickness is usually carried out by measuring the thickness of coating. However, the thickness of the coating is very small in the present invention, so it is very difficult to measure the thickness. In addition, since the surface of the substrate, such as a metal, is not necessarily flat, this makes it even more difficult to measure the thickness.

In the prior art, there is also a method using a weight meter. However, since the thickness of the coating is very small in the present invention, there is a problem of large measurement errors.

The inventor of the present invention has surprisingly found that the thickness of the silicate coating of the present invention can be measured by fluorescent X-ray spectrometry. This measurement method is simple and rapid, and more importantly, it is highly applicable to thin coatings.

In a preferred embodiment of the present invention for measuring the thickness of the silicate coating by fluorescent X-ray spectrometry, the silicate coating has a thickness of from 50 to 10,000 mg/m², preferably from 100 to 5,000 mg/m², and more preferably from 200 to 3,000 mg/m², such as from 630 to 1,450 mg/m² or from 700 to 1,400 mg/m², in terms of SiO₂.

In a preferred embodiment, the silicate is an alkali metal silicate, and preferably, the alkali metal is selected from lithium, sodium and potassium.

In a preferred embodiment of the present invention for measuring the thickness of the silicate coating by fluorescent X-ray spectrometry, the silicate coating is the alkali metal silicate coating according to the present invention or an alkali metal silicate coating which can be prepared by the method according to the present invention.

As described above, in order to measure the thickness, calibration curves of the thickness in terms of SiO₂ (mg/m²) may be pre-prepared, and then the thickness of the coating may be calculated based on the calibration curves.

The alkali metal silicate coating of the present invention has excellent heat resistance, hot water resistance and stain resistance, as well as excellent damage resistance.

The technical solutions of the present invention will be further described hereinbelow in conjunction with specific examples of the present invention, but they should not be understood as the limitations to the protection scope of the present invention. The examples described hereinbelow are only a part of the examples of the present invention, not all the examples. Based on the examples enumerated in the present invention, other examples put forward by those skilled in the art without creative work shall fall within the protection scope of the present invention.

### EXAMPLES

The present invention will be illustrated in detail by the examples and comparative examples hereinbelow, but the present invention is not limited by the examples.

In the implementation of the present invention, the following evaluation methods are adopted:

1) With regard to fluorescent X-ray spectrometry, a X-MET8000 fluorescent X-ray analyser manufactured by Hitachi High-Technologies Corporation is used. The intensity of the characteristic X-ray Kα line of SiO₂ standard sample with a known thickness (mg/m²) is pre-measured, so as to prepare calibration curves of thickness in terms of SiO₂. Then the intensity of the Kα line of a prepared test sample with an unknown thickness is measured, so as to calculate the thickness of the test sample in terms of SiO₂ based on the calibration curves.

2) With regard to appearance, a coating that is transparent without foaming and whitening shall be considered qualified.

3) With regard to heat discoloration resistance, a prepared test sample is placed in an electric furnace heated to 400° C. for 2 hours, and the whitening (including foaming) of the coating and the discoloration of the substrate metal (especially the yellow discoloration, known as temper colour, in the case of a stainless steel substrate) are examined visually. Those without discoloration shall be considered qualified.

4) With regard to hot water resistance, an electric kettle (of Zojirushi brand) is used with a water temperature set to 60° C. A coated test plate is soaked therein for 24 hours, and then taken out for evaluation (see the evaluation method below); then the water temperature is set to 98° C., and the same test plate is soaked therein for 2 hours, and then taken out for evaluation.

Evaluation method: after the test plate is taken out, the excess water on the surface of the test plate is wiped off at first, and the coating is visually checked for discoloration; after that, a curve is drawn on the surface (coated surface) of the test plate with an oil-based pen (black pen [symbol] made by Zebura Co., Ltd. in Japan); after drying for 1 minute, it is wiped with a sponge dampened with water to check whether it still has stain resistance. It shall be considered qualified if the ink curve can be wiped off, or otherwise unqualified if the ink curve cannot be wiped off.

5) With regard to stain resistance, a curve is drawn on the surface with a black oil-based pen [symbol] made by Zebura Co., Ltd. in Japan, and is visually checked as to whether it can be wiped off with water after drying. It shall be considered qualified if there is no remaining oil film.

6) With regard to damage resistance, it is scratched with a 9H pencil in accordance with JIS K 5600 scratch hardness (pencil method) and visually checked for the occurrence of damage. Those without damage shall be considered qualified.

### Examples 1 to 3 and Comparative Examples 1 to 2

40 g of Sodium Silicate J3 manufactured by Nippon Chemical Industrial Co., Ltd. (SiO₂: 29.1%, Na₂O: 9.3%, the molar ratio of SiO₂ to Na₂O (value of n): 3.2, with the remainder being water), 26.7 g of Lithium Silicate 45 manufactured by Nippon Chemical Industrial Co., Ltd. (SiO₂: 21.2%, Li₂O: 2.4%, the molar ratio of SiO₂ to Li₂O (value of m): 4.4, with the remainder being water), and 33.3 g of water were added into a 100 ml polypropylene container, and stirred to obtain a mixed aqueous solution with a molar ratio of sodium silicate (M₂O.nSiO₂) to lithium silicate (Li₂O.mSiO₂) of 2.8. The mixed aqueous solution was spray-coated onto a SUS 304 No. 4 finished stainless steel plate (20×30 cm) as a substrate, and the spraying device used was W100-082P spray gun by Anest Iwata Corporation. The spraying amount was about 0.5 g, 0.7 g, 1.0 g, 1.3 g, and 1.5 g in Comparative Example 1, Example 1, Example 2, Example 3, and Comparative Example 2, respectively (the sprayed mixed solution would not be fully attached to the surface of stainless steel, and the actual coating thickness still needed to be quantified by fluorescent X-ray spectrometry). Then natural drying was carried out for 10 minutes, followed by heat treatment in an oven at 250° C. for 30 minutes. After being naturally cooled, the test plate was evaluated by the evaluation method as described above. The results are shown in Table 1.

TABLE 1
Evaluation results of stainless steel test plates (baked at 250° C.)

| | Thickness | | | | | | |
|---|---|---|---|---|---|---|---|
| | in Terms | | Heat | Hot Water | Hot Water | | |
| | of SiO₂ | | Resistance | Resistance | Resistance | Ink Stain | 9 H Pencil |
| | (mg/m²) | Appearance | at 400° C. | at 98° C., 2 h | at 60° C., 24 h | Resistance | Hardness |
| Comparative | 520 | qualified | unqualified | qualified | qualified | qualified | unqualified |
| Example 1 | | | (yellowing) | | | | |
| Example 1 | 730 | qualified | qualified | qualified | qualified | qualified | qualified |
| Example 2 | 1,050 | qualified | qualified | qualified | qualified | qualified | qualified |
| Example 3 | 1,370 | qualified | qualified | qualified | qualified | qualified | qualified |
| Comparative | 1,590 | unqualified | unqualified | unqualified | unqualified | unqualified | unqualified |
| Example 2 | | (whitening) | (more | | | | |
| | | | whitening) | | | | |

As shown from the results in Table 1, the fluorescent X-ray spectrometry can be used to measure the thicknesses of silicate coatings.

### Examples 4 to 6 and Comparative Examples 3 to 4

The procedures in Example 2 were repeated, except that the baking temperatures shown in Table 2 were adopted. The evaluation results are shown in Table 2.

TABLE 2
Evaluation results of stainless steel plates by varying the baking temperature (the thickness of
the silicate coating in 1050 mg/m² in terms of SiO₂ as measured by fluorescent X-ray spectrometry)

| | Baking | | Heat | Hot Water | Hot Water | | |
|---|---|---|---|---|---|---|---|
| | Temperature | | Resistance | Resistance | Resistance | Ink Stain | 9 H Pencil |
| | (° C.) | Appearance | at 400° C. | at 98° C., 2 h | at 60° C., 24 h | Resistance | Hardness |
| Comparative | 180 | qualified | qualified | unqualified | unqualified | qualified | qualified |
| Example 3 | | | | | | | |
| Example 4 | 200 | qualified | qualified | qualified | qualified | qualified | qualified |
| Example 5 | 400 | qualified | qualified | qualified | qualified | qualified | qualified |
| Example 6 | 500 | qualified | qualified | qualified | qualified | qualified | qualified |
| Comparative | 600 | unqualified | unqualified | unqualified | unqualified | unqualified | unqualified |
| Example 4 | | (whitening) | (whitening) | | | | |

As shown from the results in Table 2, when a baking temperature of 180° C. is used, the resulting alkali metal silicate coating has insufficient hot water resistance; and when a baking temperature of 600° C. is used, the appearance of the resulting alkali metal silicate coating whitens.

### Example 7 and Comparative Examples 5 to 6

The procedures in Example 2 were repeated, except that the mixed aqueous solution was prepared with the molar ratios of M₂O.nSiO₂ to Li₂O.mSiO₂ shown in Table 3. Specifically, in terms of operations, Sodium Silicate J3 and Lithium Silicate 45 are in a weight ratio of 6:4 and a molar ratio of 2.8 in Example 2. Sodium Silicate J3 and Lithium Silicate 45 are in a weight ratio of 7:3 and a molar ratio of 4.4 in Example 7. Furthermore, Sodium Silicate J3 and Lithium Silicate 45 are in a weight ratio of 5:5 and a molar ratio of 1.9 in Comparative Example 5, and Sodium Silicate J3 and Lithium Silicate 45 are in a weight ratio of 7.5:2.5 and a molar ratio of 5.7 in Comparative Example 6.

In addition, in order to facilitate coating, 33% by weight of water was further added to the mixed aqueous solution. The evaluation results are shown in Table 3.

TABLE 3
Evaluation results by varying the molar ratio (the baking temperature is 250° C., and the thickness
is about 1050 mg/m² in terms of SiO₂)

| | | | Heat | Hot Water | Hot Water | | |
|---|---|---|---|---|---|---|---|
| | Molar | | Resistance | Resistance | Resistance | Ink Stain | 9 H Pencil |
| Difference | Ratio | Appearance | at 400° C. | at 98° C., 2 h | at 60° C., 24 h | Resistance | Hardness |
| Comparative | 1.9 | qualified | unqualified | qualified | qualified | qualified | unqualified |
| Example 5 | | | (whitening) | | | | |
| Example 2 | 2.8 | qualified | qualified | qualified | qualified | qualified | qualified |
| Example 7 | 4.4 | qualified | qualified | qualified | qualified | qualified | qualified |
| Comparative | 5.7 | qualified | qualified | unqualified | unqualified | qualified | qualified |
| Example 6 | | | | | | | |

As shown from Table 3, when the molar ratio of M₂O.nSiO₂ to Li₂O.mSiO₂ is 1.9, the alkali metal silicate coating exhibits insufficient heat resistance; and when the molar ratio of the two is 5.7, the resulting coating exhibits insufficient hot water resistance.

### Comparative Examples 7-10

The procedures of Example 2 were repeated, except that sodium silicate with the values of n as shown in Table 4 was used in place of the sodium silicate in Example 2, and lithium silicate with the values of m as shown in Table 4 was used in place of the lithium silicate in Example 2. The evaluation results are shown in Table 5.

In Table 4, Sodium Silicate No. 2 is Sodium Silicate 45-2 manufactured by Nippon Chemical Industry Co., Ltd., Sodium Silicate No. 3 is Sodium Silicate J3 manufactured by Nippon Chemical Industry Co., Ltd., and Sodium Silicate No. 4 is Sodium Silicate 4 manufactured by Nippon Chemical Industry Co., Ltd. In Table 4, Lithium Silicate No. 35 is Lithium Silicate 35 manufactured by Nippon Chemical Industry Co., Ltd., Lithium Silicate No. 45 is Lithium Silicate 45 manufactured by Nippon Chemical Industry Co., Ltd., and Lithium Silicate No. 75 is Lithium Silicate 75 manufactured by Nippon Chemical Industry Co., Ltd.

TABLE 4
Varying the value of n and the value of m

| | Sodium | Lithium | | | |
|---|---|---|---|---|---|
| | Silicate | Silicate | n | m | Molar Ratio |
| Example 2 | No. 3 | 45 | 3.2 | 4.4 | 2.8 |
| Comparative | No. 2 | 45 | 2.7 | 4.4 | 3.5 |
| Example 7 | | | | | |
| Comparative | No. 4 | 45 | 3.8 | 4.4 | 2.0 |
| Example 8 | | | | | |
| Comparative | No. 3 | 35 | 3.2 | 3.5 | 2.1 |
| Example 9 | | | | | |
| Comparative | No. 3 | 75 | 3.2 | 7.5 | 4.5 |
| Example 10 | | | | | |

TABLE 5
Evaluation results by varying the value of n and the value of m

| | | Heat | Hot Water | Hot Water | | 9 H |
|---|---|---|---|---|---|---|
| | | Resistance | Resistance | Resistance | Ink Stain | Pencil |
| Difference | Appearance | at 400° C. | at 98° C., 2 h | at 60° C., 24 h | Resistance | Hardness |
| Example 2 | qualified | qualified | qualified | qualified | qualified | qualified |
| Comparative | qualified | qualified | unqualified | unqualified | qualified | qualified |
| Example 7 | | | | | | |
| Comparative | qualified | unqualified | qualified | qualified | qualified | qualified |
| Example 8 | | (whitening) | | | | |
| Comparative | qualified | qualified | unqualified | unqualified | qualified | qualified |
| Example 9 | | | | | | |
| Comparative | qualified | unqualified | qualified | qualified | qualified | qualified |
| Example 10 | | (whitening) | | | | |

### Example 8

67 g of Potassium Silicate 2K (SiO₂: 21.0%, K₂O: 9.0%, the molar ratio of SiO₂ to K₂O (value of n): 3.7, with the remainder being water) manufactured by Nippon Chemical Industry Co., Ltd., 33 g of Lithium Silicate 45 (SiO₂: 21.2%, Li₂O: 2.4%, the molar ratio of SiO₂ to Li₂O (value of m): 4.4, with the remainder being water) manufactured by Nippon Chemical Industry Co., Ltd., and 100 g of water were added into a 200 ml polypropylene container, and stirred to obtain a mixed aqueous solution with a molar ratio of M₂O.nSiO₂ to Li₂O.mSiO₂ of 2.4. The mixed aqueous solution was dip-coated onto a SUS 430 No. 4 finished stainless steel plate as a substrate. The thickness was set to 1050 mg/m² in terms of SiO₂ (the lifting speed of the stainless steel plate after dipping was set to 1 mm/min). Natural drying was carried out for 10 minutes, followed by heat treatment in an oven at 250° C. for 30 minutes. After being naturally cooled, the test plate was evaluated by the evaluation method as described above. The evaluation results are shown in Table 6.

### Comparative Example 11

A SUS 430 No. 4 finished stainless steel plate without coatings was used directly, and the test plate was evaluated by the evaluation method as described above. The evaluation results are shown in Table 6.

### Comparative Example 12

The procedures of Example 8 were repeated, except that potassium silicate was used solely without lithium silicate. The evaluation results are shown in Table 6.

### Example 9

The procedures of Example 8 were repeated, except that an aluminium plate was used as a substrate. The evaluation results are shown in Table 6.

### Comparative Example 13

An aluminium plate without coatings was used directly, and the test plate was evaluated by the evaluation method as described above. The evaluation results are shown in Table 6.

### Comparative Example 14

The procedures of Example 8 were repeated, except that an aluminium plate was used as a substrate, and potassium silicate was used solely without lithium silicate. The evaluation results are shown in Table 6.

TABLE 6
Evaluation results of coatings using potassium silicate

| | | | | Heat | Hot Water | Hot Water | | |
|---|---|---|---|---|---|---|---|---|
| | | | | Resistance | Resistance | Resistance | Ink Stain | 9 H Pencil |
| | Substrate | Silicate | Appearance | at 400° C. | at 98° C., 2 h | at 60° C., 24 h | Resistance | Hardness |
| Example 8 | Stainless | potassium | qualified | qualified | qualified | qualified | qualified | qualified |
| | steel | silicate and | | | | | | |
| | | lithium | | | | | | |
| | | silicate | | | | | | |
| Comparative | Stainless | none | qualified | unqualified | qualified | qualified | unqualified | unqualified |
| Example 11 | steel | | | (yellowing) | | | | |
| Comparative | Stainless | potassium | qualified | qualified | unqualified | unqualified | qualified | qualified |
| Example 12 | steel | silicate | | | | | | |
| | | solely | | | | | | |
| Example 9 | aluminium | potassium | qualified | qualified | qualified | qualified | qualified | qualified |
| | | silicate and | | | | | | |
| | | lithium | | | | | | |
| | | silicate | | | | | | |
| Comparative | aluminium | none | qualified | qualified | unqualified | unqualified | unqualified | unqualified |
| Example 13 | | | | | (blackening) | (blackening) | | |
| Comparative | aluminium | potassium | qualified | qualified | unqualified | qualified | qualified | |
| Example 14 | | silicate | | | (blackening) | | | |
| | | solely | | | | | | |

As shown from the results in Table 6, with regard to the stainless steel upon coating treatment, there is no yellowing as temper colour even when it is heated at 400° C., the stain by an oil-based ink pen can be wiped off with water, and damage does not occur easily. Furthermore, in the case of aluminium, there is no blackening when it is dipped in hot water, the stains are removed similarly to the case of stainless steel, and damage does not occur easily. Moreover, in the case of potassium silicate solely, although there is no whitening and heat resistance is exhibited, the hot water resistance is insufficient.

As shown from the results as described above, the alkali metal silicate coating of the present invention has excellent heat resistance. For example, the articles such as stainless steel articles and aluminium articles having the alkali metal silicate coating of the present invention do not discolour even when they are heated at 400° C. for 2 hours.

The alkali metal silicate coating of the present invention has excellent hot water resistance. For example, the articles such as stainless steel articles and aluminium articles having the alkali metal silicate coating of the present invention can withstand hot water at about 100° C. for 2 hours and withstand hot water at 60° C. for 24 hours.

The alkali metal silicate coating of the present invention has excellent stain resistance. For example, with regard to the articles such as stainless steel articles and aluminium articles, having an alkali metal silicate coating of the present invention, the ink stains by an oil-based pen can be removed therefrom with water without using any organic solvents.

The alkali metal silicate coating of the present invention has excellent damage resistance. For example, the alkali metal silicate coating of the present invention has no damage when it is scratched by a 9H pencil.

### INDUSTRIAL APPLICABILITY

The present invention provides an alkali metal silicate coating, which does not foam/whiten at a high temperature of 200° C. or above, has excellent water resistance and hot water resistance, and exhibits excellent stain resistance and damage resistance. These various properties have not been provided according to the prior knowledge. With these properties, stainless steel or aluminium with said coating, for example, can be used in various kitchen-related appliances, general household appliance products, and vehicle-related products.

1. An alkali metal silicate coating formed from alkali metal silicate represented by the chemical formula M₂O.nSiO₂ and lithium silicate represented by the chemical formula Li₂O.mSiO₂, wherein M is selected from sodium, potassium, or a mixture thereof, n is from 2.9 to 3.7, m is from 4.2 to 4.8, and the molar ratio of M₂O.nSiO₂ to Li₂O.mSiO₂ is from 2.2 to 4.8;
wherein the alkali metal silicate coating has a thickness of from 630 to 1,450 mg/m², preferably from 700 to 1,400 mg/m², in terms of SiO₂ as measured by fluorescent X-ray spectrometry.

2. The alkali metal silicate coating according to claim 1, wherein the molar ratio of M₂.nSiO₂ to Li₂O.mSiO₂is from 2.3 to 4.5, preferably from 2.4 to 4.4.

3. The alkali metal silicate coating according to claim 1 or 2, wherein M is sodium or potassium.

4. The alkali metal silicate coating according to any one of claims 1 to 3, wherein n is from 3.0 to 3.7, and/or m is from 4.3 to 4.7.

5. A preparation method of an alkali metal silicate coating, comprising:
(i) providing a mixed aqueous solution comprising alkali metal silicate represented by the chemical formula M₂O.nSiO₂ and lithium silicate represented by the chemical formula Li₂.mSiO₂, wherein M is selected from sodium, potassium, or a mixture thereof, n is from 2.9 to 3.7, m is from 4.2 to 4.8, and the molar ratio of M₂O.nSiO₂ to Li₂O.mSiO₂ is from 2.2 to 4.8; and
(ii) coating the mixed aqueous solution in step (i) onto e surface of a substrate and then baking at a temperature of from 200 to 550° C.

6. The method according to claim 5, wherein the molar ratio of M₂O.nSiO₂ to Li₂O.mSiO₂ is from 2.3 to 4.5, preferably from 2.4 to 4.4.

7. The method according to claim 5 or 6, wherein M is sodium or potassium.

8. The method according to any one of claims 5 to 7, wherein n is from 3.0 to 3.7, and/or m is from 4.3 to 4.7.

9. The method according to any one of claims 5 to 8, wherein the mixed aqueous solution in step (i) is prepared by mixing an aqueous solution of alkali metal silicate represented by the chemical formula M₂O.nSiO₂ with an aqueous solution of lithium silicate represented by the chemical formula Li₂O.mSiO₂.

10. The method according to any one of claims 5 to 9, wherein the baking in step (ii) is carried out at a temperature of from 200 to 500° C., preferably from 200 to 300° C.

11. The method according to any one of claims 5 to 10, wherein the alkali metal silicate coating has a thickness of from 630 to 1,450 mg/m², preferably from 700 to 1,400 mg/m², in terms of SiO₂ as measured by fluorescent X-ray spectrometry.

12. The method according to any one of claims 5 to 11, wherein the baking in step (ii) is carried out for a duration of from 15 minutes to 2 hours, preferably from 20 minutes to 1 hour.

13. The method according to any one of claims 5 to 12, wherein the substrate is a metal, preferably iron, aluminium, an iron alloy such as stainless steel, an aluminium alloy, or copper, and more preferably an iron alloy such as stainless steel or aluminium.

14. An article having the alkali metal silicate coating according to any one of claims 1 to 4, or an article having an alkali metal silicate coating prepared by the method according to any one of claims 5 to 13.

15. The article according to claim 14, wherein the article is a metal article, preferably an article of iron, aluminium, an iron alloy such as stainless steel, an aluminium alloy, or copper, and more preferably an article of an iron alloy such as stainless steel or aluminium.

16. A product manufactured from the metal article according to claim 14 or 15, such as a kitchen product, a home appliance product, and a vehicle-related product.

17. A method of measuring the thickness of a silicate coating by fluorescent X-ray spectrometry.

18. The method according to claim 17, wherein the thickness of the silicate coating is from 50 to 10,000 mg/m², preferably from 100 to 5,000 mg/m², and more preferably from 200 to 3,000 mg/m², in terms of SiO₂.

19. The method according to claim 17 or 18, wherein the silicate coating is the coating according to any one of claims 1 to 4 or a coating prepared by the method according to any one of claims 5 to 13.
